(19) United States
(12) Patent Application Publication
(10) Pub. No.: US 2016/0125339 A1
(43) Pub. Date: May 5, 2016

(54) DEMAND-SUPPLY PLANNING DEVICE, DEMAND-SUPPLY PLANNING METHOD, DEMAND-SUPPLY PLANNING PROGRAM, AND RECORDING MEDIUM

(71) Applicant: MITSUBISHI ELECTRIC CORPORATION, Chiyoda-ku, Tokyo (JP)

(72) Inventor: Nobuhiko ITAYA, Chiyoda-ku, Tokyo (JP)

(73) Assignee: MITSUBISHI ELECTRIC CORPORATION, Chiyoda-ku, Tokyo, OT (JP)

(21) Appl. No.: 14/896,575

(22) PCT Filed: Jun. 26, 2013
(86) PCT No.: PCT/JP2013/067560

§ 371 Date: Dec. 7, 2015

(51) Int. Cl. G06Q 10/06; G06Q 50/06; G06Q 30/02

(52) U.S. Cl. CPC G06Q 10/06315; G06Q 30/0202; G06Q 50/06

(57) ABSTRACT

A demand-supply planning device includes: a power demand predicting unit that predicts power demand; an expected rebate value predicting unit that calculates an expected profit value per unit amount of reduced power based on an occurrence probability of a demand response and a rebate value to be acquired through the demand response; and an optimal operation plan creating unit that sets an addition result of a first cost for power purchase, a second cost for power generation in power generators and storage batteries, and a multiplication result of the expected profit value and reserve power, which is an amount of power capable of being further generated by the power generators and the storage batteries after an amount of power supplied satisfying the power demand is generated, as an evaluation function and determines an operation plan of the reserve power and the power generators and the storage batteries.

### FIELD

The present invention relates to a demand-supply planning device, a demand-supply planning method, a demand-supply planning program, and a recording medium.

### BACKGROUND ART

Power demand and supply are approximately partitioned into a supply party and a consumer party. The supply party includes power companies and the like and the consumer party includes factories/buildings/ordinary homes. The contract capacity (maximum amount of power received) of each consumer is determined. However, due to the problem of cost, in general, the supply party does not prepare for power generation capacity corresponding to the total contract capacities of all the consumers but predicts an amount of power used by the consumers and prepares for an amount of power generated which is equal to or greater than the predicted amount of power to be used. Methods of creating such a demand-supply plan are disclosed, for example, in Patent Literatures 1 and 2 described below.

However, with recent tight demand-supply balance, the predicted power demand often exceeds the amount of power supplied which is prepared by the supply party and thus a response (demand response) of the consumer party based on a request from the supply party has been studied. On the other hand, there are a lot of consumers that have power generation facilities or power storage facilities, introduce their own plan control system, and perform an energy saving operation. Such consumers have a possibility of greatly contributing to reduction in power demand by an increase in an amount of power generated, discharging of storage batteries, or the like in addition to a simple load suppression.

Various types of demand responses have been thought out. For example, a type can be considered in which a rebate is given according to an amount of power decreased when an amount of power received in several hours in which the demand-supply tightness is predicted is made to be lower than an amount of power received in a normal state (for example, which is calculated based on results of amounts of power received in one week in the past) (when an amount of power purchased is decreased or an amount of power sold is increased).

### CITATION LIST

### Patent Literature

Patent Literature 1: Japanese Patent Application Laid-Open No. 2005-004435

Patent Literature 2: Japanese Patent Application Laid-Open No. 2010-213477

### SUMMARY

### Technical Problem

However, in the method of creating a demand-supply plan of a consumer in the related art, an operation plan of a power generator or a storage battery is drawn up so as to minimize an operational cost (=power generation cost+power purchase cost−power selling cost) in a predetermined period (for example, the next one day or the next one week). In general, regarding a demand-supply plan, power demand is first predicted and then a power generation plan suitable for the predicted power demand is drafted. Accordingly, if the power demand is accurately predicted, an accurate operation plan with a minimized operational cost can be drafted. However, the smaller the demand scale becomes, the more it becomes difficult to predict the power demand. As a countermeasure, it can be considered that the power demand that is difficult to predict is treated probabilistically and, for example, a demand suppress request is treated as a probabilistic fluctuation of the power demand, as described in Patent Literatures 1 and 2.

On the other hand, when it is necessary to set an amount of power purchased in a specific time zone of a specific day (for example, a period of time of 13:00 to 16:00 on a day on which the temperature is particularly high and the power demand is predicted to be great in the whole nation in the summer) to be lower than that in the normal state (for example, an average value of amount of power purchased at a period of time of 13:00 to 16:00 in one week in the past) in response to a power purchase suppress request (demand response request) from the outside, there is no room to decrease the amount of power purchased if the power generator generates power with the maximum output power or the storage battery is maximally discharged in that time zone in the normal state. However, when the output power of the power generator is excessively lowered or the storage battery is excessively charged in the time zone in the normal state in preparation for the demand response, there is a possibility that power costs in the normal state will increase greatly.

In general, it is assumed that a demand response request is issued on a day or several hours before the time zone in which power consumption suppression is desired. Accordingly, it is preferable as a demand response measure that a normal optimal demand-supply plan be drawn up when no request is issued and the optimal demand-supply plan be drawn up again in consideration of a rebate when a request is issued, but there are following problems in this case.
In response to a sudden suppression request several hours before or the like, there is a possibility that start of power generators will be delayed or charging of storage batteries will not be done in time. Even in time, a sudden change of a plan will cause a high operational cost or will not be compensated for a rebate for load suppression.
In normal operations in a time zone of a month in which there is a high possibility of power demand-supply tightness, it is thought that there have already been many cases where the power generators are often fully operated. In this case, even when the rebate for the power purchase suppression request is very high, power cannot be generated any more.

From the viewpoint of the entire society, it can be thought that power which can be generated or discharged from the consumers having the power generation facilities or the electric storage facilities is reserve power for the whole society. Accordingly, it is preferable from the viewpoint of the whole society that the consumers having the power generation facilities or the electric storage facilities operate the power generators and the storage batteries possessed by the consumers, in normal operations in a time zone of a month in which there is a high possibility of power demand-supply tightness, in such a manner as to have appropriate reserve power (an amount of power which can be immediately generated/discharged when it is intended to generate/discharge more power).

The present invention is made in consideration of the above-mentioned circumstances and an object thereof is to provide a demand-supply planning device, a demand-supply planning method, a demand-supply planning program, and a recording medium that can create a demand-supply plan for operating a power generator and a storage battery to have appropriate reserve power for coping with a demand response request.

### Solution to Problem

In order to solve the aforementioned problems, a demand-supply planning device according to one aspect of the present invention is so constructed as to include: a power demand predicting unit that performs prediction of power demand; an expected profit value predicting unit that calculates an expected profit value per unit amount of reduced power based on an occurrence probability of a demand response and a rebate value to be acquired through the demand response; and an optimal operation plan creating unit that sets an addition result of, a first cost for power purchase, a second cost for power generation by a power supply facility, and a multiplication result of the expected profit value and reserve power, which is an amount of power capable of being further generated by the power supply facility after an amount of power supplied satisfying the power demand is generated, as an evaluation function, and determines the reserve power and an operation plan of the power supply facility so as to satisfy the power demand with an amount of power purchased and the amount of power generated by the power supply facility, to satisfy a constraint condition of the power supply facility when the reserve power is generated, and to minimize the evaluation function.

### Advantageous Effects of Invention

According to the present invention, it is possible to create a demand-supply plan for operating a power generator and a storage battery to have appropriate reserve power for coping with a demand response request.

### BRIEF DESCRIPTION OF DRAWINGS

FIG. 1 is a diagram illustrating a functional configuration example of a demand-supply planning device according to a first embodiment of the present invention.

FIG. 2 is a diagram illustrating a configuration example of a computer system which is the demand-supply planning device according to the present invention.

FIG. 3 is a diagram illustrating an example of data which is stored in a storage unit.

FIG. 4 is a flowchart illustrating an example of an operation plan creating process which is performed every 24 hours.

FIG. 5 is a diagram illustrating an example of reserve power.

FIG. 6 is a diagram illustrating advantageous effects of the embodiment.

FIG. 7 is a diagram illustrating an example of an operation plan defining process which is performed every update cycle.

### DESCRIPTION OF EMBODIMENTS

Hereinafter, a demand-supply planning device, a demand-supply planning method, a demand-supply planning program, and a recording medium according to embodiments of the present invention will be described in detail with reference to the accompanying drawings. The present invention is not limited to the embodiments.

### Embodiments

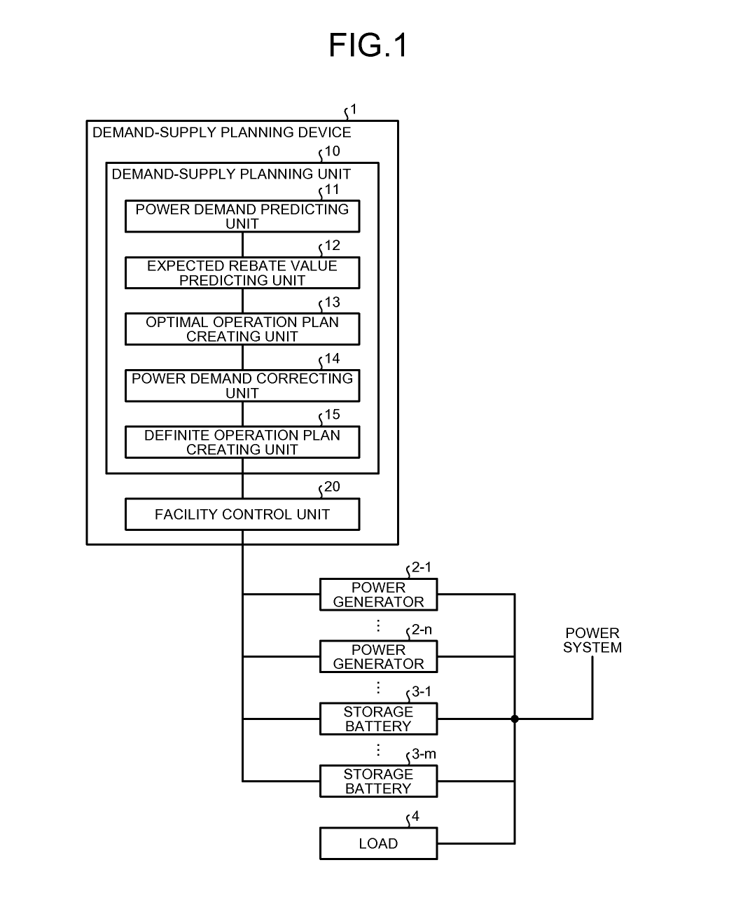

FIG. 1 is a diagram illustrating a functional configuration example of a demand-supply planning device according to a first embodiment of the present invention. The demand-supply planning device 1 according to this embodiment is a device of a consumer party and is connected to power generators 2-1 to 2-n and storage batteries 3-1 to 3-m which are owned (managed) by consumers. The power generators 2-1 to 2-n and the storage batteries 3-1 to 3-m are connected to a power system and are supplied with power from a supply party such as a power company. The power generators 2-1 to 2-n and the storage batteries 3-1 to 3-m are connected to a load 4 via power distribution lines. The load 4 is supplied with power from the power generators 2-1 to 2-n and the storage batteries 3-1 to 3-m or from the power system. Only one load 4 is illustrated in FIG. 1 for the purpose of simplification, but the load 4 may include plural facilities. In FIG. 1, consumers have both power generators and storage batteries, but may have either one of the power generators and the storage batteries.

As illustrated in FIG. 1, the demand-supply planning device according to this embodiment includes a demand-supply planning unit 10 and a facility control unit 20. The demand-supply planning unit 10 includes a power demand predicting unit 11, an expected rebate value predicting unit (expected profit value predicting unit) 12, an optimal operation plan creating unit 13, a power demand correcting unit 14, and a definite operation plan creating unit 15. The facility control unit 20 controls the power generators 2-1 to 2-n and the storage batteries 3-1 to 3-m based on an operation plan which is created by the demand-supply planning unit 10. The power generators 2-1 to 2-n and the storage batteries 3-1 to 3-m are power supply facilities capable of supplying power to the load 4. The power generators 2-1 to 2-n and the storage batteries 3-1 to 3-m may supply power to the outside as well as to the load 4, when a power transaction contract is made with a power company or the like.

In this embodiment, the demand-supply planning device 1 includes the facility control unit 20, but a control device other than the demand-supply planning device 1 may include the facility control unit 20 and the control device may control the power generators 2-1 to 2-n and the storage batteries 3-1 to 3-m based on an operation plan which is created by the demand-supply planning device 1.

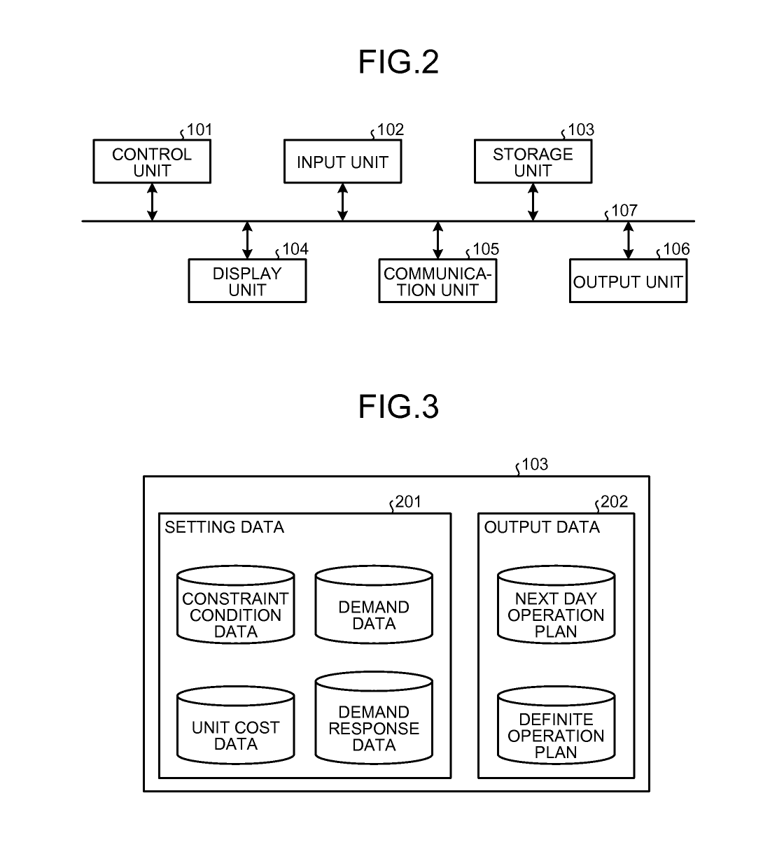

Specifically, the demand-supply planning device 1 is a computer system (computer). By causing the computer system to execute a demand-supply planning program, the computer system functions as the demand-supply planning device 1. FIG. 2 is a diagram illustrating a configuration example of the computer system according to this embodiment. As illustrated in FIG. 2, the computer system includes a control unit 101, an input unit 102, a storage unit 103, a display unit 104, a communication unit 105, and an output unit 106 which are connected to one another via a system bus 107.

In FIG. 2, the control unit 101 is, for example, a central processing unit (CPU) and executes the demand-supply planning program according to this embodiment. The input unit 102 is constituted by, for example, a keyboard, a mouse and the like, and is used for a user of the computer system to input a variety of information. The storage unit 103 includes various memories such as a random access memory (RAM) and a read only memory (ROM) and a storage device such as a hard disk and stores programs to be executed by the control unit 101 and necessary data acquired through the processing. The storage unit 103 may be used as a temporary memory area of a program. The display unit 104 is constituted by a liquid crystal display panel (LCD) or the like and displays various screens for the user of the computer system. The communication unit 105 has a function of connecting to a network such as a local area network (LAN) and transmits control commands for the power generators 2-1 to 2-n and the storage batteries 3-1 to 3-m to the power generators 2-1 to 2-n and the storage batteries 3-1 to 3-m. The output unit 106 is constituted by a printer or the like and has a function of outputting process results to the outside. The configuration illustrated in FIG. 2 is only an example and the configuration of the computer system is not limited to the example illustrated in FIG. 2. For example, the computer system may not include the output unit 106.

Now, an operation example of the computer system until the demand-supply planning program according to the present invention is made executable will be described. In the computer system having the above-mentioned configuration, the demand-supply planning program is installed in the storage unit 103, for example, from a CD-ROM/DVD-ROM set into a compact disc (CD)-ROM/digital versatile disc (DVD)-ROM drive (not illustrated). When the demand-supply planning program is executed, the demand-supply planning program read from the storage unit 103 is stored in a predetermined area of the storage unit 103. In this state, the control unit 101 performs a demand-supply plan creating process according to this embodiment in accordance with the program stored in the storage unit 103.

In this embodiment, the program in which the demand-supply plan creating process is described using the CD-ROM/DVD-ROM as a recording medium (demand-supply planning program) is provided, but the present invention is not limited to this configuration and, for example, a program provided from a transmission medium such as the Internet via the communication unit 105 may be used in accordance with the configuration of the computer system, the capacity of the program to be provided, and the like.

The demand-supply planning unit 10 and the facility control unit 20 illustrated in FIG. 1 are included in the control unit 101 illustrated in FIG. 2. FIG. 3 is a diagram illustrating an example of data which is stored in the storage unit 103. The storage unit 103 stores setting data 201 which is used in the demand-supply plan creating process according to this embodiment and output data 202 of the demand-supply plan creating process according to this embodiment. The setting data 201 includes constraint condition data, unit cost data, demand data, and demand response data. The output data 202 includes a next day operation plan and a definite operation plan. Details of the setting data 201 and the output data 202 will be described later.

Operations of this embodiment will be described below. In this embodiment, first, an operation plan (next day operation plan) is created every predetermined period (for example, 24 hours) (first cycle). At the point in time at which the operation plan is created, since it is not determined whether a demand response is to be performed, a rebate for the demand response is introduced into an evaluation function based on the occurrence probability of the demand response. Then, for each predetermined update cycle (for example, one hour) (second cycle), the demand in the next day operation plan is corrected according to the newest information and a definite operation plan is created. The facility control unit 20 controls the power generators 2-1 to 2-n and the storage batteries 3-1 to 3-m in accordance with the definite operation plan. At this time, when the demand response is not performed, the definite operation plan is created without introducing the rebate for the demand response into the evaluation function based on the information on definition of whether to perform/not to perform the demand response. Hereinafter, in this embodiment, the predetermined period is set to 24 hours (a first operation plan is created every 24 hours) and the update cycle is set to one hour (a second operation plan is created every one hour), but the predetermined period and the update cycle are not limited to these values. For example, the predetermined period may be set to one week or may be set to any value as long as the predetermined period is greater than the update cycle.

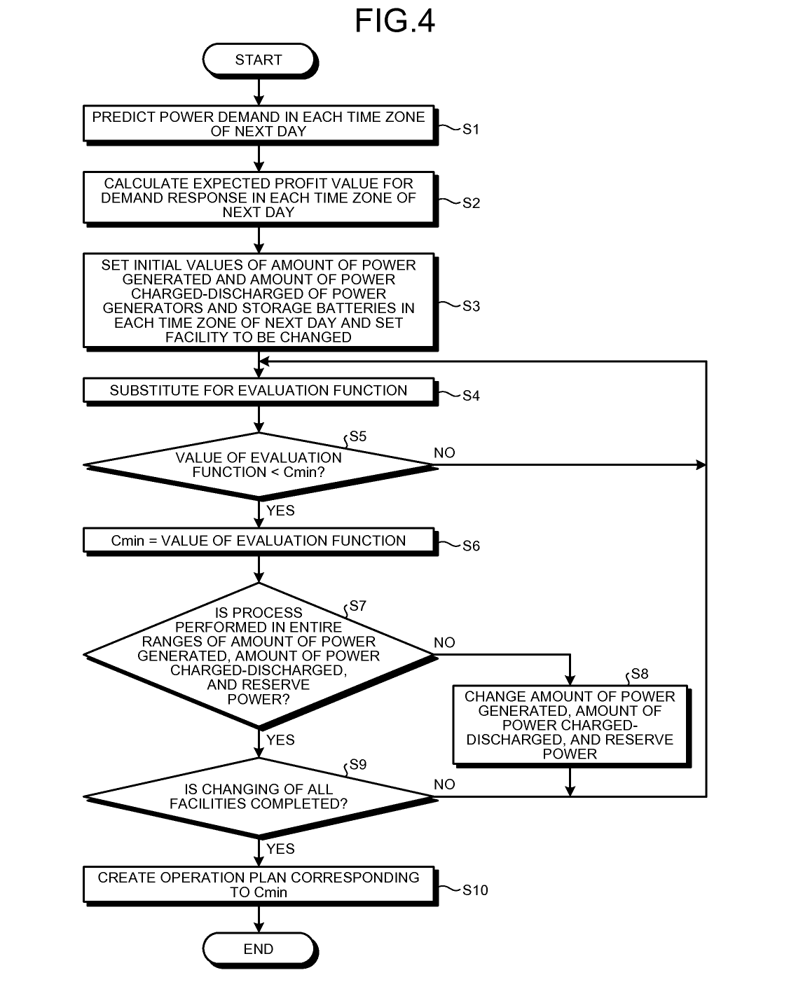

FIG. 4 is a flowchart illustrating an example of the operation plan creating process which is performed every 24 hours. First, the power demand predicting unit 11 predicts power demand in each time zone of the next day (step S1). The length of each time zone is set to be, for example, the same as the update cycle and is set to one hour herein, but is not limited to one hour. Any method may be used as the method of predicting the power demand, and for example, methods of calculating the power demand based on past demand results and parameters such as seasons (or month), days of a week, time zones of a day, and predicted temperature values may be used. For example, it is assumed that past demand results are recorded as demand data in the storage unit 103 in correlation with the parameters such as seasons, days of a week, time zones of a day, and predicted temperature values. The result values of the season, the day of a week, and the time zone of a day to be predicted are extracted from the demand data, a correlation between the temperature and the result values is acquired based on the extracted result values, and a predicted demand value is calculated using the acquired correlation and the predicted temperature value. Here, since a consumer predicts its own demand, an operation plan of manufacturing facilities and the like in a business place which is a part of the load 4 may be determined in advance. Information on dates and time zones in which the facilities having a definite operation plan should be operated can be stored as the demand data and the operation plan can be reflected in the demand prediction. In this case, the demand data includes operation/non-operation of each facility as past data. The facilities may be classified into facilities of which power demand can be predicted by the operation plan and facilities of which the power demand varies in accordance with the consumer temperature like air-conditioning facilities. Regarding the former, predicted power consumption values of each operation plan and each facility may be calculated, the correlation with the temperature and the like may be calculated based on the past data only in consideration thereof, and the predicted demand value may be calculated using the calculated correlation and the predicted temperature value.

Then, the expected rebate value predicting unit 12 calculates an expected profit value which is a unit profit (for example, per 1 kWh) resulting from a rebate to be returned when a demand response occurs (step S2). The expected profit value is specifically calculated, for example, as follows. The method of setting the rebate for a demand response is not particularly defined, and for example, a method of setting the rebate to X yens per 1 kWh as a decrease in an amount of power purchased (or an increase in an amount of power sold) from that in a normal state can be considered. X may be changed according to a time zone or a date, but is uniformly 40 yen herein. The demand response data in the storage unit 103 includes a rebate value (unit rebate value) per unit amount of power. The occurrence probability of the demand response varies according to the seasons or time zones. The probabilities according to the seasons and the time zones are stored as the demand response data in the storage unit 103. For example, the occurrence probability in a time zone 13:00 to 16:00 of July/August is stored to be high (for example, 50%) and the probabilities in other time zones are stored to be low (for example, 0%). The occurrence probability in each season and each time zone or the unit rebate value (for example, uniformly 40 yen per 1 kWh) can be changed by the supply party according to the predicted power demand-supply tightness of the nation. When these values are changed, for example, an operator of a consumer updates the demand response data in the storage unit 103. When the unit rebate value varies according to the time zones, the rebate value in each time zone is stored as the demand response data.

In a case in which several years have elapsed after an operation using the demand response is started, the occurrence probability of the demand response can be calculated on the basis of the frequency of the demand response in each time zone of the seasons or months in the past. If the past results in the past (results in which the demand response was performed or was not performed in the past) have not been stored, the occurrence probability that is predicted by prediction of the weather or the temperature or the like can be used.

When the probabilities of the demand response calculated based on the past results are finely acquired and the use thereof without any change is anticipated to cause a process to be described later complicated, the probabilities may be simplified to be used by setting the occurrence probability to 0 when the occurrence probability ranges from 0% to 10%, setting the occurrence probability to 20% when the occurrence probability ranges from 20% to 30%, and the like.

The expected rebate value predicting unit 12 reads the corresponding unit rebate value (the rebate value per unit amount of reduced power (unit reduced power)) and the occurrence probability thereof for each time zone of a next day from the demand response data in the storage unit 103. An expected rebate value is calculated by multiplying the unit rebate value by the occurrence probability for each time zone of the next day. For example, when the unit rebate value is uniformly 40 yen per 1 kWh, the occurrence probability thereof is 50% in the time zone of 13:00 to 16:00 of July/August, and the occurrence probability thereof is 0% in the other time zones, the expected rebate value in the time zone of 13:00 to 14:00 of July is 20 yen per 1 kWh and the expected rebate value in the time zone of 16:00 to 17:00 of July is 0 yen per 1 kWh.

The expected rebate value predicting unit 12 calculates the expected profit value by subtracting a cost such as a fuel cost for generating (generating or discharging) a unit amount of power (1 kWh herein) from the expected rebate value for each type of the power generators 2-1 to 2-n and the storage batteries 3-1 to 3-m. Here, the costs for generating a unit amount of power in the power generators 2-1 to 2-n are the same, the costs for generating a unit amount of power in the storage batteries 3-1 to 3-m are the same, the power supply facilities are divided into the power generators (the power generators 2-1 to 2-n) and the storage batteries (the storage batteries 3-1 to 3-m), and the expected profit value is calculated, for example, using Expression (1) as follows.

Expected profit value [power generator]=expected rebate value×unit fuel cost

Expected profit value [storage battery]=expected rebate value×storage battery loss×power purchase unit cost (1)

In Expression (1), the unit fuel cost is a cost of fuel used to generate the unit amount of power (1 kWh herein). The storage battery loss is a ratio (for example, 30%) of a charging-discharging loss in the storage battery to the amount of power used for the charging and discharging. The power purchase unit cost is a power purchase unit cost when power is purchased from a power company or the like at the time of charging the storage battery. The unit fuel cost, and the power purchase unit cost are stored in the unit cost data in the storage unit 103. The expected rebate value predicting unit 12 reads the values from the unit cost data in the storage unit 103 and uses the read values for the above-mentioned calculation.

When the power generators 2-1 to 2-n having different unit fuel costs are present, the expected profit value [power generator] only has to be calculated for each of the power generators 2-1 to 2-n. When the storage batteries 3-1 to 3-m having different storage battery losses are present, the expected profit value [storage battery] only has to be calculated for each of the storage batteries 3-1 to 3-m.

Referring to FIG. 4 again, subsequently, the optimal operation plan creating unit 13 sets initial values (initial profiles) of power generation/charging-discharging profiles of the power generators 2-1 to 2-n and the storage batteries 3-1 to 3-m for each time zone of a next day (step S3). At this time, the power generation/charging-discharging profiles are changed in the subsequent step to create an optical operation plan, but an initial value is selected and set for the power generators 2-1 to 2-n and the storage batteries 3-1 to 3-m (facilities to be changed) of which the power generation/charging-discharging profiles are changed. Regarding the reserve power as well, an initial profile (for example, which is zero in all the time zones) is set as profiles of reserve power (reserve power profiles) for the power generators 2-1 to 2-n and the storage batteries 3-1 to 3-m. Here, the power generation/charging-discharging profiles in this embodiment indicate amounts of power generated/charged-discharged at the same time interval (for example, one hour) as the power demand. For example, in the power generation/charging-discharging profiles, operations for each time zone are defined, such as all the power generators 2-1 to 2-n generate power in the time zone of 10:00 to 16:00 but do not generate power in the other time zones, and the storage batteries 3-1 to 3-m are charged in the night and early time zone (for example, 0:00 to 6:00) until the SOC thereof reaches 60% and are discharged in the time zone of 7:00 to 8:00. The power generation/charging-discharging profiles of the power generators are determined according to the start time of each power generator, the stop time of each power generator, the amount of power generated (per unit time), and the like. The power generation/charging-discharging profiles of the storage batteries are determined according to the charging start time, the charging rate, the discharging start time, the discharging rate, and the like.

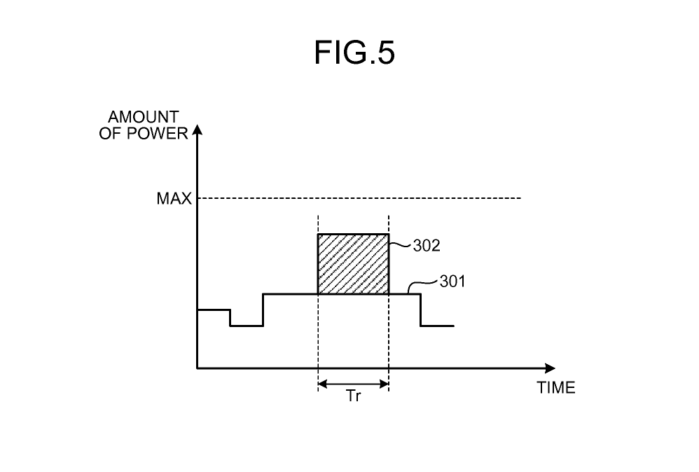

The reserve power is an amount of power which can be generated (generated in case of the power generators and discharged or decreased in the charging power in case of the storage battery) by the facilities of the consumer party (the power generators 2-1 to 2-n and the storage batteries 3-1 to 3-m) when a demand response occurs, and is determined to minimize the evaluation function in consideration of the rebate for the demand response to be described later. FIG. 5 is a diagram illustrating an example of the reserve power. FIG. 5 illustrates an example of a power generation profile 301 and reserve power 302 of a power generator. The period Tr in FIG. 5 refers to a time zone in which the occurrence probability of the demand response is high.

In setting the initial profiles of the power generation/charging-discharging profiles and the reserve power profiles, the optimal operation plan creating unit 13 reads the constraint condition data stored in the storage unit 103 and reflects the read constraint condition data. Specifically, the initial profiles are set such that the power generation/charging-discharging profiles alone satisfy the constraint conditions and profiles obtained by adding the reserve power profiles to the power generation/charging-discharging profiles satisfy the constraint conditions. For example, in the example illustrated in FIG. 5, the initial profiles are set such that the power generation profile 301 satisfies the constraint conditions and a profile obtained by adding the reserve power 302 in the period Tr thereto satisfies the constraint conditions. Accordingly, even in the case in which the reserve power 302 is added, the resultant profile is equal to or less than the maximum amount of power generated and it is thus possible to secure reserve power when the demand response occurs. For example, the constraint conditions are as follows.

(1) Constraint conditions of power generator
Continuous operation time (for example, 20 hours or less)
Pause time (time to be interposed between stop and restart, for example, 4 hours or more)
Number of times of starting stop (for example, one time or less/day)
Maximum amount of power generated/minimum amount of power generated (per unit time)

(2) Constraint conditions of storage battery
Maximum amount of power charged-discharged (for example, ±10 kW)
State of charge (SOC) constraint (for example, 70% or less, 30% or more)

(3) Constraint conditions of amount of power purchased
Maximum/minimum value of an amount of power purchased from a supply party such as a power company

The optimal operation plan creating unit 13 substitute the amount of power purchased, the amount of power generated, the amount of power discharged, and the reserve power for each time zone for the evaluation function, based on the power generation/charging-discharging profiles, the reserve power profiles, and the demand predicted in step S1 (step S4). For example, Expression (2) described below is used as the evaluation function.

Evaluation function=Σₜ(amount of power purchased×power purchase unit cost+amount of power generated×unit fuel cost+amount of power discharged×storage battery loss×power purchase unit cost [charging]−Σᵢ(reserve power×expected profit value) (2)

The amount of power purchased is obtained by subtracting the amounts of power generated by the power generators 2-1 to 2-n and the amounts of power charged-discharged by the storage batteries 3-1 to 3-m from the amount of power corresponding to the predicted demand. Here, the amount of power charged-discharged is set to a plus sign in case of discharging and is set to a minus sign in case of charging. For example, in a time zone in which only the charging is performed, the amount of power required for the charging is added to the amount of power purchased. Σₜ in the head of Expression (2) refers to the total sum with respect to the time, is defined as the total sum of one day (24 hours) which is the cycle time of creating the operation plan, and is the total sum of the values in 24 time zones when the power demand and the like are calculated hourly. When the power purchase unit cost varies depending on the time zones, the power purchase unit cost which is multiplied by the storage battery loss is set to a unit cost at the time of charging. Σᵢ in Expression (2) refers to the total sum in groups when the groups having different expected profit values such as the power generators and the storage batteries are present. For example, when the power generators 2-1 to 2-n can use the same expected profit value [power generator], and the storage batteries 3-1 to 3-m can use the same expected profit value [storage battery], Σᵢ(reserve power×expected profit value) can be represented by Expression (3).

Σᵢ(reserve power×expected profit value)=total reserve power of power generators 2-1 to 2-n×expected profit value [power generator]+total reserve power of storage batteries 3-1 to 3-m×expected profit value [storage battery] (3)

The amount of power purchased×power purchase unit cost (first cost) in Expression (2) refers to a cost required for power purchase, and the amount of power generated×unit fuel cost+amount of power discharged×storage battery loss (second cost refers to a cost required for generating power from the power supply facilities (the power generators 2-1 to 2-n and the storage batteries 3-1 to 3-m) of the consumer party.

In this embodiment, since the demand is demand in the facilities of the consumer party, a temporal distribution of the demand may be changed to a certain extent. In this case, the total demand of one day only has to be supplied on a daily basis. In this case, in step S8 described later on, a range of change is determined, including a case in which the temporal demand distribution is changed when the power generation/charging-discharging profiles are changed. Here, when the changeable range of the operation plan is constrained or an unchangeable load is present, these are also considered as the constraint conditions. For example, as for a manufacturing facility as a part of the load 4, the constraint condition is that the profiles are changeable in one hour before or after the start and end of the operation from the operation plan.

The optimal operation plan creating unit 13 determines whether the value of evaluation function for which the amount of power purchased, the amount of power generated, the amount of power discharged, the reserve power, and the like are substituted in step S4 is less than Cmin (step S5). A sufficiently great value (for example, a value greater than the obtainable maximum value of the evaluation function) is set as the initial value of Cmin. When the value of the evaluation function is less than Cmin (Yes in step S5), Cmin is set as the value of the evaluation function (step S6). Then, the optimal operation plan creating unit 13 determines whether the power generation/charging-discharging profiles and the reserve power profiles of the facilities to be changed are processed in the entire changeable range (step S7), changes the power generation/charging-discharging profiles and/or the reserve power profiles (step S8) when a range in which the processing is not yet performed is still present (No in step S7), and returns the process flow to step S4. In the changing in step S8, the profiles are changed such that the changed power generation/charging-discharging profiles alone satisfy the constraint conditions and the profiles obtained by adding the changed reserve power profiles to the changed power generation/charging-discharging profiles also satisfy the constraint conditions, in the same way as setting the initial profiles.

The entire changeable range is a range which can be set based on the above-mentioned constraint conditions (1) to (3). A constraint condition other than the constraint conditions (1) to (3) may be added to narrow the entire changeable range. For example, the power generators may be started and stopped once a day and the power generation profiles may be changed by changing only the operation start time with the operation time of a day determined. Regarding the reserve power profiles, the reserve power does not need to be set in a period during which the demand response is 0% in the example in which the occurrence probability of the demand response is set to 50% in the time zone of 13:00 to 16:00 of July/August and is set to 0% in the other time zones as described above. Accordingly, the value of the reserve power in only the time zone in which the occurrence probability is 50% may be changed to calculate a value that optimizes the evaluation function. The changing of the charging-discharging profiles and the reserve power profiles may be performed, for example, by changing the reserve power profiles with the power generation/charging-discharging profiles fixed and changing the power generation/charging-discharging profiles after the entire range of the reserve power profiles are processed or using other methods. In order to reduce a processing load, the power generation/charging-discharging profiles may be changed by providing plural power generation/charging-discharging profiles for each facility in advance and selecting the power generation/charging-discharging profiles therefrom.

When it is determined in step S7 that the entire range is processed (Yes in step S7), it is determined whether the changing for all the facilities is completed (are set as the facilities to be changed) (step S9), one of the facilities of which the changing is not completed is set as a facility to be changed when a facility of which the changing is not completed is present (No in step S9), and the process flow is returned to step S4. When the changing of all the facilities is completed (Yes in step S9), an operation plan is created on the basis of the power generation/charging-discharging profiles corresponding to Cmin (step S10) and is stored as a next day operation plan (first operation plan) in the storage unit 103, and the process flow ends. When the next day operation plan (first operation plan) is stored in the storage unit 103, the reserve power profiles are stored and the predicted power demand value calculated in step S1 and the preconditions (such as the predicted temperature) of the predicted value are stored in the storage unit 103 in correlation with each other. However, the above-mentioned process flow is an example, and the specific processes are not limited to the above-mentioned process flow as long as it can calculate the power generation/charging-discharging profiles and the reserve power profiles which minimize the value of the evaluation function.

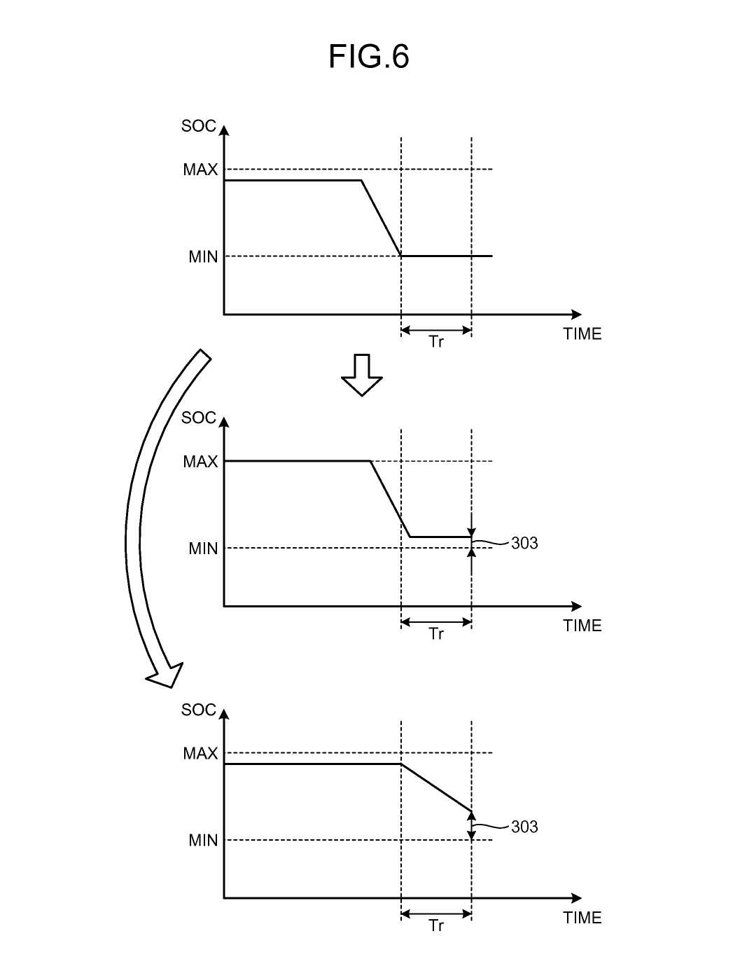

Through the above-mentioned processes, it is possible to create an operation plan which can secure reserve power minimizing the evaluation function. The demand-supply planning device 1 according to this embodiment can draft a demand-supply plan in consideration of the rebate for the demand response through the above-mentioned processes. FIG. 6 is a diagram illustrating advantageous effects of this embodiment. The upper part of FIG. 6 illustrates the SOC in a storage battery when an operation is performed without securing the reserve power, and the middle part and the lower part of FIG. 6 illustrate the SOC in a storage battery when an operation is performed such that reserve power is secured. In the upper part of FIG. 6, discharging is started from the value of the SOC less than a maximum value (MAX). In the period Tr (period in which the occurrence probability of the demand response is high), the SOC reaches a minimum value (MIN) and discharging cannot be performed any longer even when the demand response is requested. On the other hand, in the middle part of FIG. 6, since the start time and speed of discharging are the same as in the upper part but discharging is started from the maximum value of the SOC, there is a margin 303 to be discharged in the period Tr. This margin corresponds to the reserve power. In addition, if the operation plan of the load 4, that is, the demand profile, can be changed, the margin 303 to be discharged in the period Tr can be enhanced by shifting the start time of discharging as illustrated in the lower part of FIG. 6. In this way, a value minimizing the evaluation function may be calculated by changing the operation plan of the load 4 in the same way as changing the power generation/charging-discharging profiles in the above-mentioned processes.

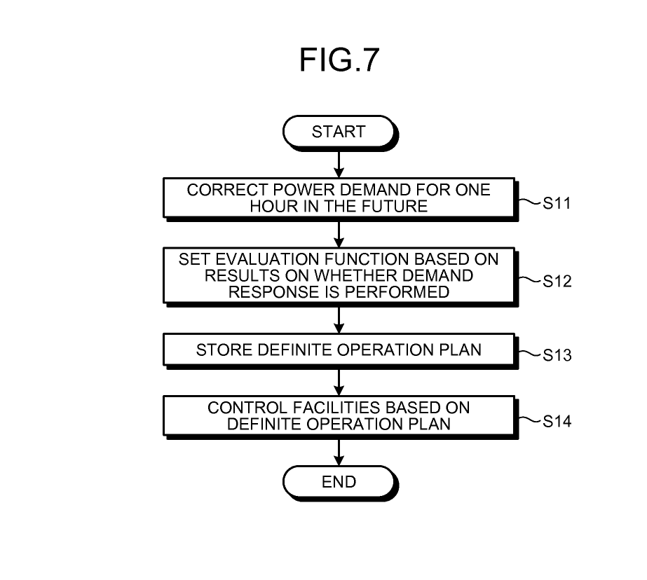

Processes which are performed per update cycle will be described below. FIG. 7 is a diagram illustrating an example of a process flow of the operation plan determining process which is performed per update cycle. First, the power demand correcting unit 14 reads the predicted power demand value from the storage unit 103 and corrects the power demand for the next one hour according to the newest temperature or the like (step S11). Specifically, for example, when the newest temperature is higher than the predicted temperature, a process of enhancing the power demand or the like is performed. When solar batteries are included as the power generators 2-1 to 2-n, the amount of power generated varies according to the weather and thus the amount of power generated may be corrected according to the actual weather.

Then, the definite operation plan creating unit 15 sets the evaluation function according to the result (definite information) as to whether the demand response is to be performed (step S12). Whether the demand response is performed may be input from an operator, for example, by operating the input unit 102 or may be input from another information device (not illustrated) via the communication unit 105.

In the process of step S12, specifically, Expression (4) is used when the demand response is performed, and Expression (5) from which the rebate is deleted is used when the demand response is not performed. Here, it is assumed that correction of the power demand in step S11 has been reflected in the amount of power purchased.

(When it is determined that the demand response is performed)

Evaluation function=amount of power purchased×power purchase unit cost+amount of power generated×unit fuel cost+amount of power discharged×storage battery loss×power purchase unit cost−Σᵢ(reserve power×unit rebate value) (4)

(When it is determined that the demand response is not performed)

Evaluation function=amount of power purchased×power purchase unit cost+amount of power generated×unit fuel cost+amount of power discharged×storage battery loss×power purchase unit cost (5)

Then, the definite operation plan creating unit 15 determines an operation plan for the next one hour according to the evaluation function set in step S12 and stores the determined operation plan as a definite operation plan (second operation plan) in the storage unit 103 (step S13). At this time, it can be considered that the operation plan that minimizes the evaluation function is calculated by sequentially changing the amount of power generated and the amount of power discharged on the basis of the same constraint conditions as in creating the operation plan of the next day in FIG. 4, but the processing load may be reduced by correcting the amount of power by only the change in power demand using the operation plan of the next day in FIG. 4 as a base. For example, the minimum value of the evaluation function may be calculated by using the operation plan of the next day in FIG. 4 as an initial value and performing the changing to decrease the reserve power and the changing to increase the amount of power generated or the amount of power discharged in changing the amounts of power generated/charged-discharged and the reserve power in the repeated loop, for example, when the demand increases. When it is determined that the demand response is not performed, the minimum value of the evaluation function may be calculated by using the operation plan (operation plan not adding the reserve power) of the next day in FIG. 4 as an initial value and performing the changing to increase the amount of power generated or the amount of power discharged when the demand increases.

The facility control unit 20 controls the facilities in accordance with the definite operation plan (step S14). When an accurate operation plan is not necessary by separately performing the control of the facilities and the like, the operation plan determining process described with reference to FIG. 7 may not be performed.

As described above, in this embodiment, the reserve power is calculated to minimize the evaluation function using a function, which is obtained by multiplying the reserve power by the expected profit value for the demand response in consideration of the occurrence probability of the demand response based on the costs (the cost for power purchase and the cost for power generation) necessary for securing the predicted power demand, as the evaluation function indicating the cost in a predetermined period. Accordingly, it is possible to create an operation plan (demand-supply plan) for operating the power generators and the storage batteries so as to have appropriate reserve power capable of coping with a demand response request.

### INDUSTRIAL APPLICABILITY

As described above, the demand-supply planning device, the demand-supply planning method, the demand-supply planning program, and the recording medium according to the present invention can be suitably used to create a demand plan in a consumer having a power generator and a storage battery and can be particularly suitably used for a consumer receiving a demand response request.

### REFERENCE SIGNS LIST

1 demand-supply planning device, 2-1 to 2-n power generator, 3-1 to 3-m storage battery, 4 load, 10 demand-supply planning unit, 11 power demand predicting unit, 12 expected rebate value predicting unit, 13 optimal operation plan creating unit, 14 power demand correcting unit, 15 definite operation plan creating unit, facility control unit, 101 control unit, 102 input unit, 103 storage unit, 104 display unit, 105 communication unit, 106 output unit, 107 system bus

1. A demand-supply planning device comprising:
a power demand predicting unit that performs prediction of power demand;
an expected profit value predicting unit to calculate an expected profit value per unit amount of reduced power based on an occurrence probability of a demand response and a rebate value to be acquired through the demand response; and
an optimal operation plan creating unit to set a result of subtracting a multiplication result of the expected profit value and reserve power, which is an amount of power capable of being further generated by the power supply facility after an amount of power supplied satisfying the power demand is generated from an addition result of a first cost for power purchase, a second cost for power generation by a power supply facility, as an evaluation function, and to determine the reserve power and an operation plan of the power supply facility so as to satisfy the power demand with an amount of power purchased and the amount of power generated by the power supply facility, to satisfy a constraint condition of the power supply facility when the reserve power is generated, and to minimize the evaluation function.

2. The demand-supply planning device according to claim 1, wherein the power demand predicting unit and the optimal operation plan creating unit perform prediction of the power demand and determination of the operation plan for each first cycle, and
wherein the demand-supply planning device further comprises:
a power demand correcting unit correcting the power demand per second cycle which is shorter than the first cycle; and
a definite operation plan creating unit that corrects the operation plan to create a definite operation plan according to the corrected power demand and the determination result as to whether the demand response should be performed for each second cycle.

3. The demand-supply planning device according to claim 2, further comprising a facility control unit that controls the power supply facility according to the definite operation plan.

4. The demand-supply planning device according to claim 1, wherein the power supply facility includes a power generator,
the second cost includes, when power is generated by the power generator, a multiplication result of a fuel cost per unit amount of power generated and an amount of power generated by the power generator, and
wherein the expected profit value of the power generator is calculated by multiplying a value, which is obtained by subtracting the fuel cost per unit amount of power generated when power is generated by the power generator from the rebate value per unit amount of reduced power to be acquired through the demand response, by the occurrence probability.

5. The demand-supply planning device according to claim 1, wherein the power supply facility includes a storage battery,
the second cost includes a multiplication result of a power purchase unit cost when the storage battery is charged, a charging-discharging loss of the storage battery, and an amount of power discharged from the storage battery, and
wherein the expected profit value of the storage battery is calculated by multiplying a value, which is obtained by subtracting the multiplication result of the power purchase unit cost and the charging-discharging loss of the storage battery when the storage battery is charged from the rebate value per unit amount of reduced power to be acquired through the demand response, by the occurrence probability.

6. A demand-supply planning method comprising:
predicting power demand;
predicting expected profit value by calculating an expected profit value per unit amount of reduced power based on an occurrence probability of a demand response and a rebate value to be acquired through the demand response; and
creating optimal operation plan by setting a result of subtracting a multiplication result of the expected profit value and reserve power, which is an amount of power capable of being further generated by the power supply facility after an amount of power supplied satisfying the power demand is generated from an addition result of a first cost for power purchase, a second cost for power generation by a power supply facility, as an evaluation function, and determining the reserve power and an operation plan of the power supply facility so as to satisfy the power demand with an amount of power purchased and the amount of power generated by the power supply facility, to satisfy a constraint condition of the power supply facility when the reserve power is generated, and to minimize the evaluation function.

7. (canceled)

8. A computer-readable recording medium that stores therein a computer program that causes a computer to execute the demand-supply planning method according to claim 6.
